(19) United States
(12) Patent Application Publication
(10) Pub. No.: US 2011/0213987 A1
(43) Pub. Date: Sep. 1, 2011

(54) CONTROLLER FOR DATA STORAGE DEVICE, DATA STORAGE DEVICE, AND CONTROL METHOD THEREOF

(75) Inventor: Takashi KUZUHARA, Tokyo (JP)

(73) Assignee: KABUSHIKI KAISHA TOSHIBA, Tokyo (JP)

(21) Appl. No.: 12/917,341

(22) Filed: Nov. 1, 2010

(30) Foreign Application Priority Data
Feb. 26, 2010 (JP) 2010-043384

(51) Int. Cl. G06F 12/14; H04L 9/06

(52) U.S. Cl. 713/189

(57) ABSTRACT

According to one embodiment, a controller that controls a data storage device provided with a storage module that stores data encrypted with a first key includes an input/output module, encryption/decryption modules, and a connector. The input/output module manages data input and output between the storage module and a host. The encryption/decryption modules are switched to function as an encryptor or a decryptor. The connector changes connection between the encryption/decryption modules and the host. When encrypted data is backed up, one of the encryption/decryption modules is switched to function as a decryptor, while the other is switched to function as an encryptor. The decryptor, the encryptor, and the host are connected in series. The encrypted data is decrypted by the decryptor with the first key and is then encrypted by the encryptor with a second key to be output to the host.

### CROSS-REFERENCE TO RELATED APPLICATIONS

This application is based upon and claims the benefit of priority from Japanese Patent Application No. 2010-043384, filed Feb. 26, 2010, the entire contents of which are incorporated herein by reference.

### FIELD

Embodiments described herein relate generally to a controller for a data storage device, a data storage device, and a control method thereof.

### BACKGROUND

There are data storage devices that encrypt data before storing it to prevent information leakage when stolen or is disposed of. For example, Japanese Patent Application Publication (KOKAI) No. 2004-341768 discloses a magnetic disk device, i.e., hard disk drive (HDD), with encryption that encrypts plaintext data from a host and writes the encrypted data to the magnetic disk after the user is authenticated. The HDD decrypts the encrypted data on the magnetic disk to transfer the plaintext to the host after the user is authenticated. That is, when used by an authorized user, similar to a conventional HDD without using encryption, the HDD with encryption exchanges plaintext data with a host via an interface.

In a conventional technology, upon updating a data key used to encrypt or decrypt data to be stored in the magnetic disk, data is loaded from the magnetic disk into the buffer random access memory (RAM). The data is decrypted by the encryption/decryption circuit using an old data key and is once again stored in the buffer RAM. The data stored in the buffer RAM is then encrypted by the encryption/decryption circuit using a new data key, and is written back to the magnetic disk via the buffer RAM.

Even an HDD with encryption function sends plaintext data to a host if a backup HDD does not support encryption function. Accordingly, the plaintext data is stored in the backup HDD (for example, HDD of the host). Therefore, if the backup HDD is stolen or is disposed of, all information may leak therefrom, which is a security worry. To cope with this, if the host encrypts the data again using a backup key, the host is required to manage the backup key. Moreover, the host is necessitated to perform the processes except data backup always with data encryption, which increases load on the host.

As in the conventional technology, if data stored in the magnetic disk is decrypted using an old data key and once stored in the buffer RAM, and is then encrypted using a new data key and written back to the magnetic disk via the buffer RAM upon updating a data key, when the buffer RAM is located outside the integrated circuit (IC) chip provided with the encryption/decryption circuit, the decrypted data is once stored outside the one-chip IC chip, which may result in the leakage of information indicating the old and new data keys and the plaintext data to the third party.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of a magnetic disk device according to an embodiment;

FIG. 2 is an exemplary functional block diagram of an electric hardware configuration of the magnetic disk device in the embodiment;

FIG. 3 is an exemplary functional block diagram of a host interface (I/F) in a hard disk controller (HDC) in the embodiment;

FIG. 4 is an exemplary schematic diagram of a data flow in the host I/F of the HDC at the time of backup in the embodiment;

FIG. 5 is an exemplary sequence diagram of the operation of a host and the HDC of a hard disk drive (HDD) at the time of backup in the embodiment;

FIG. 6 is an exemplary schematic diagram of a data flow in the host I/F of the HDC at the time of restore in the embodiment;

FIG. 7 is an exemplary sequence diagram of the operation of the host and the HDC of the HDD at the time of restore in the embodiment;

FIG. 8 is an exemplary schematic diagram of a relationship between the host (personal computer) and the HDD at the time of backup and restore in the embodiment;

FIG. 9 is an exemplary schematic diagram of a data flow in the host I/F of the HDC at the time of updating a data key in the embodiment; and

FIG. 10 is an exemplary sequence diagram of the operation of the host and the HDC of the HDD at the time of updating a data key in the embodiment.

### DETAILED DESCRIPTION

Various embodiments will be described hereinafter with reference to the accompanying drawings. In general, according to one embodiment, a controller configured to control a data storage device provided with a storage module that stores data encrypted with a first key comprises an input and output module, a plurality of encryption and decryption modules, and a connector. The input and output module is configured to manage data input and output between the storage module and a host. The encryption and decryption modules are configured to be switched to function as an encryptor or a decryptor. The connector is configured to change connection between the encryption and decryption modules and the host. When encrypted data is backed up, one of the encryption and decryption modules on the side of the storage module is switched to function as a decryptor, while one of the encryption and decryption modules on the side of the host is switched to function as an encryptor. The decryptor, the encryptor, and the host are connected in series. The encrypted data is decrypted by the decryptor with the first key and is then encrypted by the encryptor with a second key to be output from the input and output module to the host.

According to another embodiment, a data storage device comprises a storage module, an input and output module, a plurality of encryption and decryption modules, and a connector. The storage module is configured to store data encrypted with a first key. The input and output module is configured to manage data input and output between the storage module and a host. The encryption and decryption modules are configured to be switched to function as an encryptor or a decryptor. The connector is configured to change connection between the encryption and decryption modules and the host. When encrypted data is backed up, one of the encryption and decryption modules on the side of the storage module is switched to function as a decryptor, while one of the encryption and decryption modules on the side of the host is switched to function as an encryptor. The decryptor, the encryptor, and the host are connected in series. The encrypted data is decrypted by the decryptor with the first key and is then encrypted by the encryptor with a second key to be output from the input and output module to the host.

According to still another embodiment, there is provided a control method applied to a data storage device comprising a storage module configured to store data encrypted with a first key, an input and output module configured to manage data input and output between the storage module and a host, a plurality of encryption and decryption modules configured to be switched to function as an encryptor or a decryptor, and a connector configured to change connection between the encryption and decryption modules and the host. The control method comprises: when encrypted data is backed up, switching one of the encryption and decryption modules on the side of the storage module to function as a decryptor; switching one of the encryption and decryption modules on the side of the host to function as an encryptor; connecting the decryptor, the encryptor, and the host in series; decrypting the encrypted data by the decryptor with the first key to obtain decrypted data; encrypting the decrypted data by the encryptor with a second key; and outputting the encrypted data encrypted with the second key from the input and output module to the host.

Like reference numerals refer to like parts throughout the several views of the drawings.

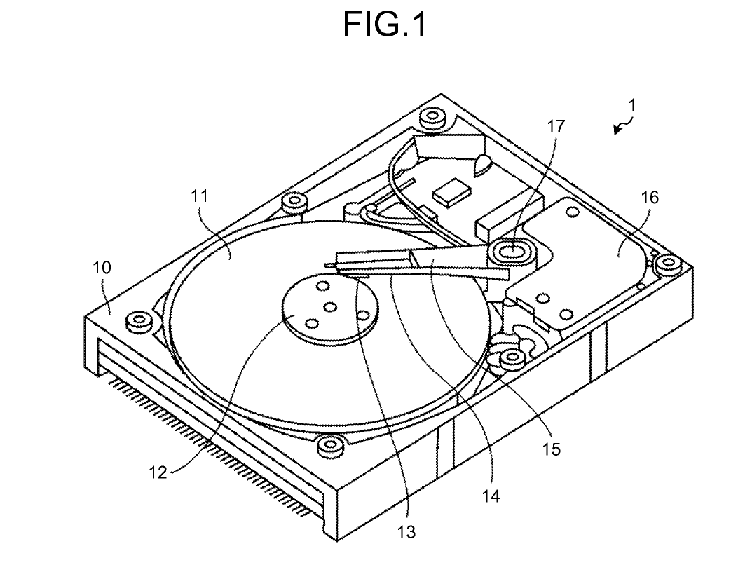

With reference to FIG. 1, a description will be given of a configuration of a magnetic disk device 1 according to an embodiment. FIG. 1 is a perspective view of the magnetic disk device 1 according to the embodiment.

As illustrated in FIG. 1, similar to commonly known hard disk drives (HDDs), the magnetic disk device 1 comprises a housing 10 that houses a magnetic disk 11, a spindle motor 12, a head slider 13, a suspension 14, and an actuator arm 15. The spindle motor rotates the magnetic disk 11. The head slider 13 is provided with a built-in magnetic head (not illustrated in FIG. 1). The magnetic disk device 1 further comprises a head suspension assembly and a voice coil motor (VCM) 16. The head suspension assembly supports the head slider 13. The VCM 16 is an actuator for the head suspension assembly.

The magnetic disk 11 is rotated by the spindle motor 12. The head slider 13 is provided with the magnetic head including a write head and a read head (none of them illustrated in FIG. 1). The actuator arm 15 is pivotally attached to a pivot 17, and the suspension 14 is attached to an end of the actuator arm 15. The head slider 13 is resiliently supported via a gimbal provided to the suspension 14. The VCM 16 is provided to the other end of the actuator arm 15. The VCM 16 rotates the actuator arm 15 about the pivot 17 to position the magnetic head so that the magnetic head floats above a radial position of the magnetic disk 11.

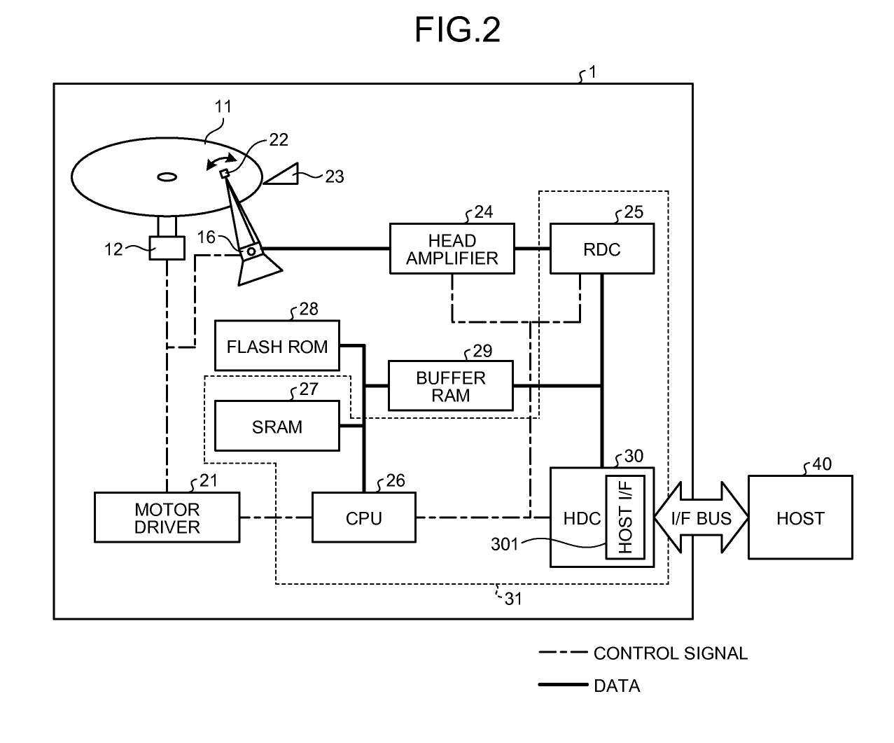

With reference to FIG. 2, a description will be given of an electric hardware configuration of the magnetic disk device 1 in the embodiment. FIG. 2 is a functional block diagram of an electric hardware configuration of the magnetic disk device 1.

In FIG. 2, the magnetic disk 11 is rotated by the spindle motor 12 (see FIG. 1) about the rotation axis at a predetermined rotational speed. The rotation of the spindle motor 12 is driven by a motor driver 21.

A magnetic head 22 includes a write head and a read head. Using the write head and the read head, the magnetic head 22 writes data to and reads data from the magnetic disk 11. As described above, the magnetic head 22 is located at an end of the actuator arm 15 and is moved in the radial direction of the magnetic disk 11 by the VCM 16 driven by the motor driver 21. When the magnetic disk 11 is not rotating, the magnetic head 22 is retracted on a ramp 23.

A head amplifier 24 amplifies a signal read by the magnetic head 22 from the magnetic disk 11 and outputs it to a read write channel (RDC) 25. The head amplifier 24 also amplifies a signal received from the RDC 25 to write data to the magnetic disk 11 and feeds it to the magnetic head 22.

The RDC 25 code-modulates data to be written to the magnetic disk 11 received from a central processing unit (CPU) 26, which will be described later, and feeds it to the head amplifier 24. The RDC 25 also code-modulates a signal read from the magnetic disk 11 and received from the head amplifier 24 and outputs it as digital data.

The CPU 26 is connected to a static random access memory (SRAM) 27 as a working memory, a flash read only memory (ROM) 28 as a nonvolatile memory, and a buffer RAM 29 as a temporary storage. The CPU 26 controls the overall operation of the magnetic disk device 1 according to firmware stored in advance in the flash ROM 28.

A hard disk controller (HDC) 30 controls data communication (including data encryption and decryption) with a host computer 40 via an interface (I/F) bus, controls the buffer RAM 29, and corrects an error in recorded data. The buffer RAM 29 is used to cache data communicated with the host computer 40 and to temporarily store data read from or to be written to the magnetic disk 11, and the like. The magnetic disk device 1 is built in or externally connected to the host computer 40. While the RDC 25, the CPU 26, the SRAM 27, and the HDC 30 constitute a controller 31 that controls the magnetic disk device 1 in the embodiment, it is not so limited. Besides, the controller 31 of the embodiment is configured as a system-on-a-chip (SoC). If the controller 31 is configured differently, among the constituent elements, at least the HDC 30 is formed of one chip. Accordingly, the salient feature of the HDC 30 described below is implemented by one-chip hardware.

A description will be given of the characteristic function and configuration of the HDC 30.

The encryption/decryption circuit of the HDC in a general HDD with encryption is implemented by a plurality of encryption/decryption circuits that realize parallel processing to ensure the data transfer capability of the interface to the host computer. For example, to achieve 3 gigabit per second (Gbps) throughput in a serial advanced technology attachment (SATA) interface using an AES-CBC encryptor supporting a 256-bit key length without parallel processing, a clock frequency of 3000*0.8/(128/17)≈319 MHz or more is required. However, by having two encryption/decryption circuits mounted in parallel, a required clock frequency is reduced to about 159 MHz, i.e., a half of that when no parallel processing is involved.

In the magnetic disk device 1 of the embodiment, the HDC 30 connects a plurality of encryption/decryption circuits (as decryptors) in parallel upon ordinary data read/write operation. On the other hand, the HDC 30 connects the encryption/decryption circuits in series upon backing up data to cause the encryption/decryption circuit at the output stage to function as an encryptor. Thus, data can be securely backed up. The backup data can be restored by applying the encryption/decryption in a reverse manner to the case of data backup with a reverse data flow.

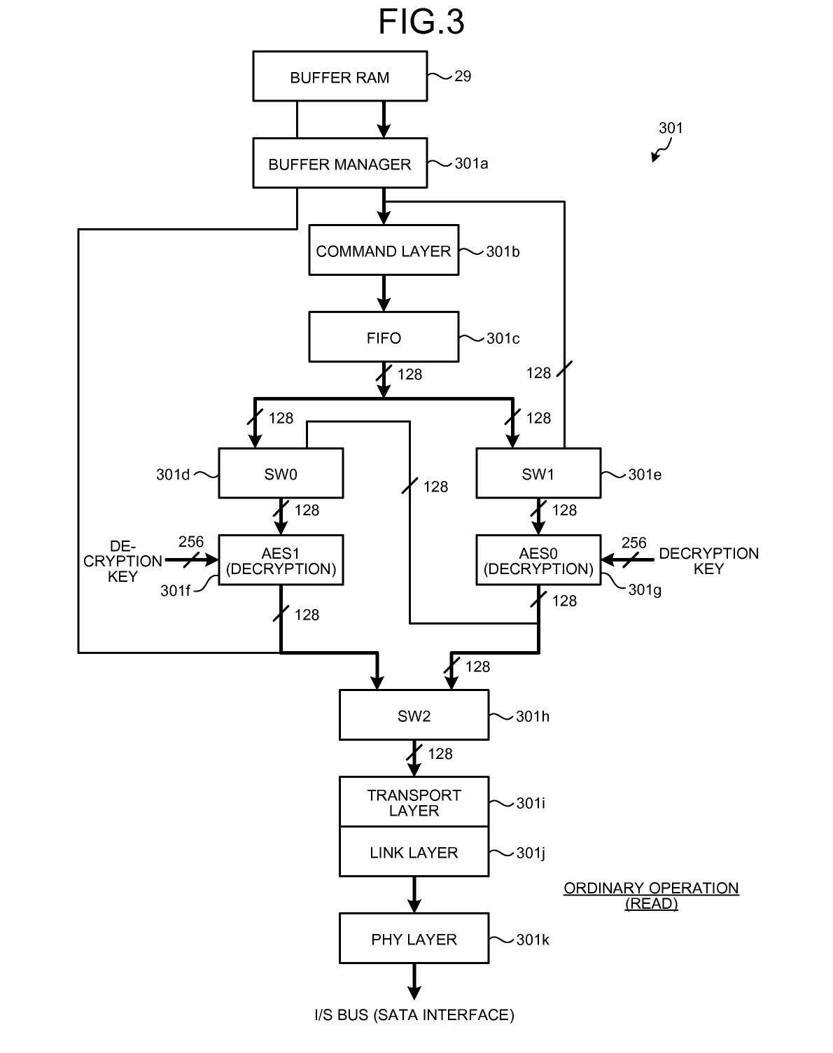

In the following, a specific configuration of the HDC 30 will be described with reference to FIG. 3. FIG. 3 is a block diagram of a host I/F 301 in the HDC 30, which is a salient feature of the embodiment. FIG. 3 illustrates an example of a configuration based on SATA. In FIG. 3, bold lines indicate a data flow during ordinary data read operation. During ordinary data write operation, encryption/decryption circuits (advanced encryption standard (AES) 0, 1) 301f and 301g function as encryptors, and data flows in a direction reverse to that of data read operation.

As illustrated in FIG. 3, at the time of ordinary data read operation, encrypted data is read from the magnetic disk 11 and temporarily stored in the buffer RAM 29. The data is then read by a buffer manager 301a from the buffer RAM 29 into the HDC 30. A command layer 301b subsequent to the buffer manager 301a is an element to perform bidirectional communication with the same language as the ATA standard. The data from the buffer RAM 29 enters in two switch circuits SWO 301d and SW1 301e through the buffer manager 301a, the command layer 301b, and a first-in, first-out (FIFO) memory 301c. The switch circuits SWO 301d and SW1 301e are switched to be connected to the FIFO memory 301c, and the encryption/decryption circuits (AES1 and AES0) 301f and 301g are switched to function as decryptors.

For example, 128-bit data from the FIFO memory 301c are sequentially decrypted by the encryption/decryption circuits (AES1 and AES0) 301f and 301g. The decrypted data are output through a switch circuit SW2 301h, a transport layer 301i, a link layer 301j, and a PHY layer 301k. The transport layer 301i, the link layer 301j, and the PHY layer 301k are compliant with the SATA specification. The transport layer 301i is an element to issue a command to control the entire protocol. The link layer 301j is an element to control the PHY layer 301k and perform data encoding. The PHY layer 301k is an element to control a SATA signal, and transfers data from the link layer 301j as serial data as well as transferring received data to the link layer 301j in a form that can be analyzed by the link layer 301j.

A description will be given of the operation of the magnetic disk device 1 having the host I/F 301 in the HDC 30 configured as above and the host computer 40 to back up data in the magnetic disk device 1 and to restore the backup data in the magnetic disk device 1.

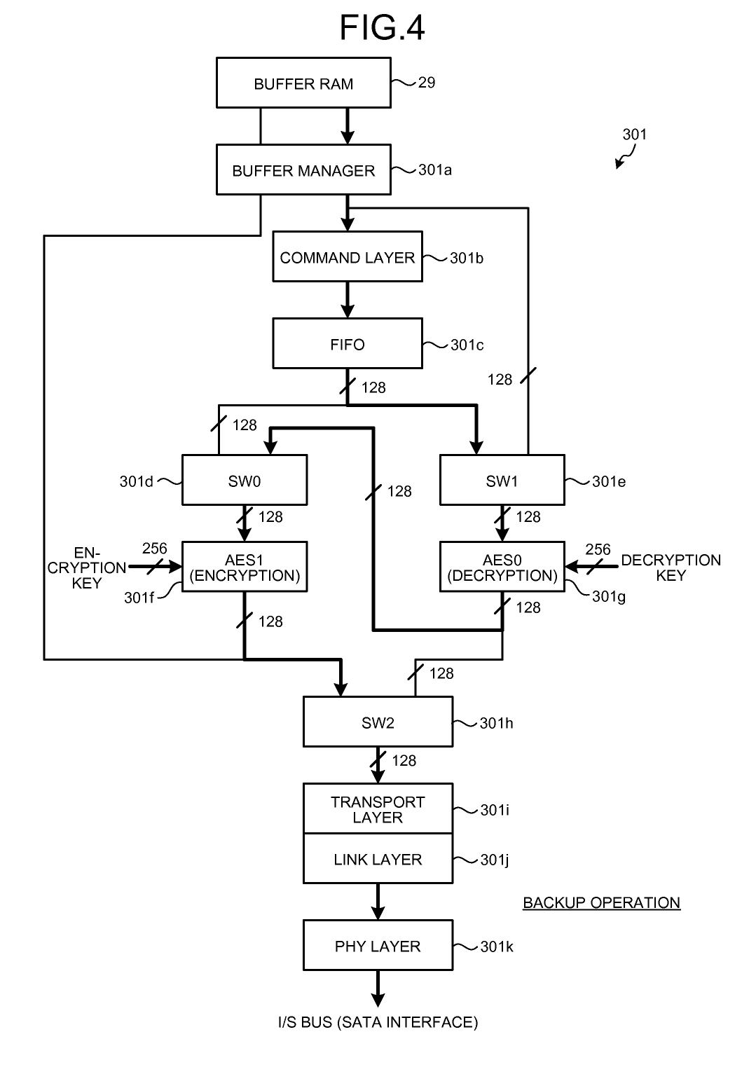

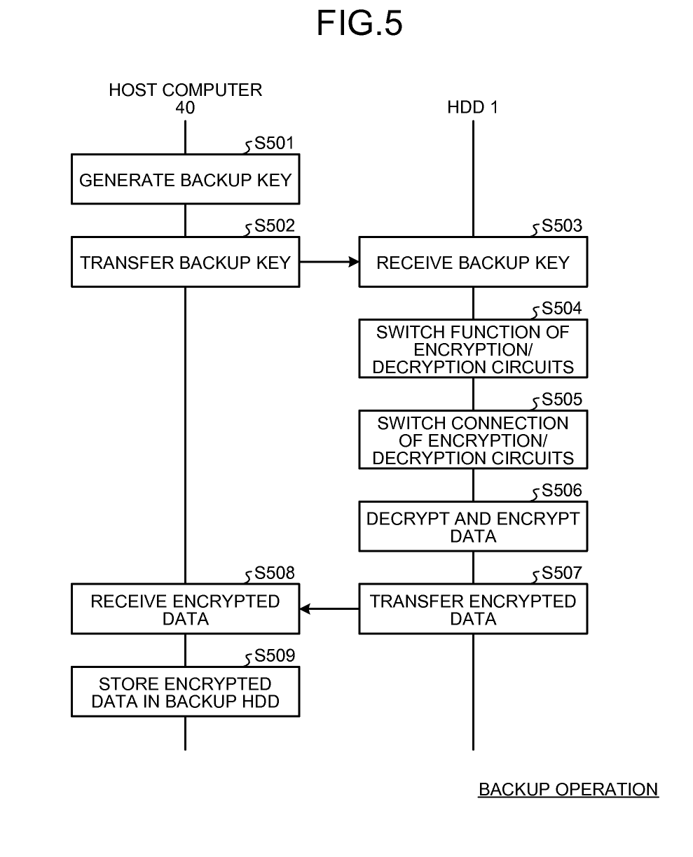

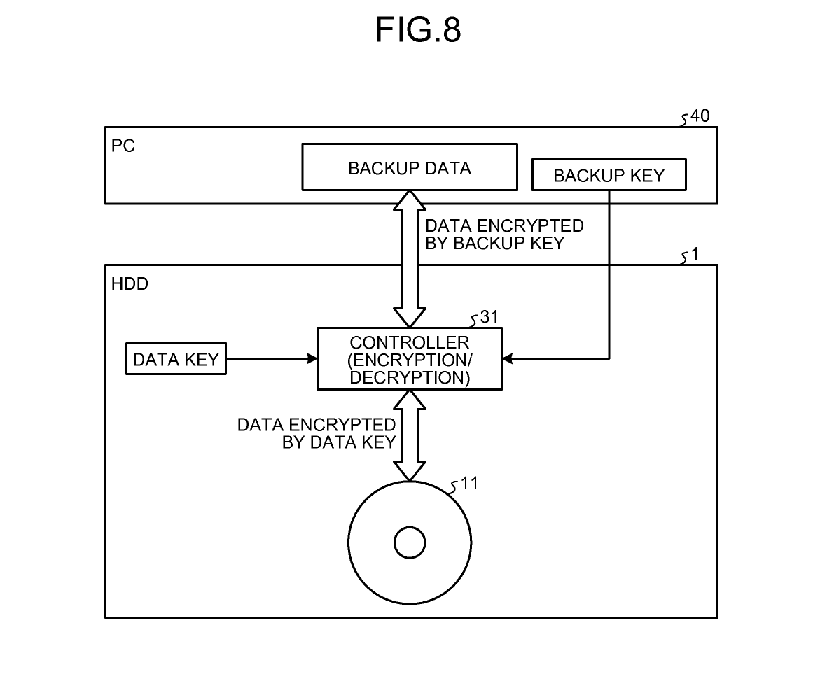

With reference to FIGS. 4, 5, and 8, the backup operation will be described. FIG. 4 is a schematic diagram of a data flow in the host I/F 301 of the HDC 30 at the time of backup. FIG. 5 is a sequence diagram of the operation of the host computer 40 and the HDC 30 of the HDD (magnetic disk device) 1 at the time of backup. FIG. 8 is a schematic diagram of a relationship between the host computer (personal computer) 40 and the HDD 1 at the time of backup and restore.

As illustrated in FIGS. 5 and 8, the host computer 40 generates a backup key to encrypt data (plaintext) to be backed up (S501). A new backup key may be generated from a random number for each backup. The host computer 40 transfers the generated backup key to the magnetic disk device 1 (S502).

The HDC 30 of the controller 31 in the magnetic disk device 1 receives the data from the host computer 40 (S503). Then, as illustrated in FIG. 4, the encryption/decryption circuit (AESO) 301g that receives the data is switched to function as a decryptor, while the encryption/decryption circuit (AES1) 301f that generates data to be written to the magnetic disk 11 is switched to function as an encryptor (S504). The encryption/decryption circuits (AES1 and AES0) 301f and 301g are connected in series (S505).

With this connection, the encryption/decryption circuit (AESO) 301g as a decryptor decrypts data read from the magnetic disk 11 using a data key generated and retained by the HDC 30. The encryption/decryption circuit (AES1) 301f as an encryptor encrypts the data read from the magnetic disk 11 and decrypted using the backup key received from the host computer 40 (S506). In this manner, the data read from the magnetic disk 11 of the magnetic disk device 1 is decrypted by the data key and encrypted by the backup key in the HDC 30, and transferred to the host computer 40 (S507).

The host computer 40 receives encrypted data transferred from the HDC 30 of the controller 31 (S508), and stores it in the backup HDD (S509).

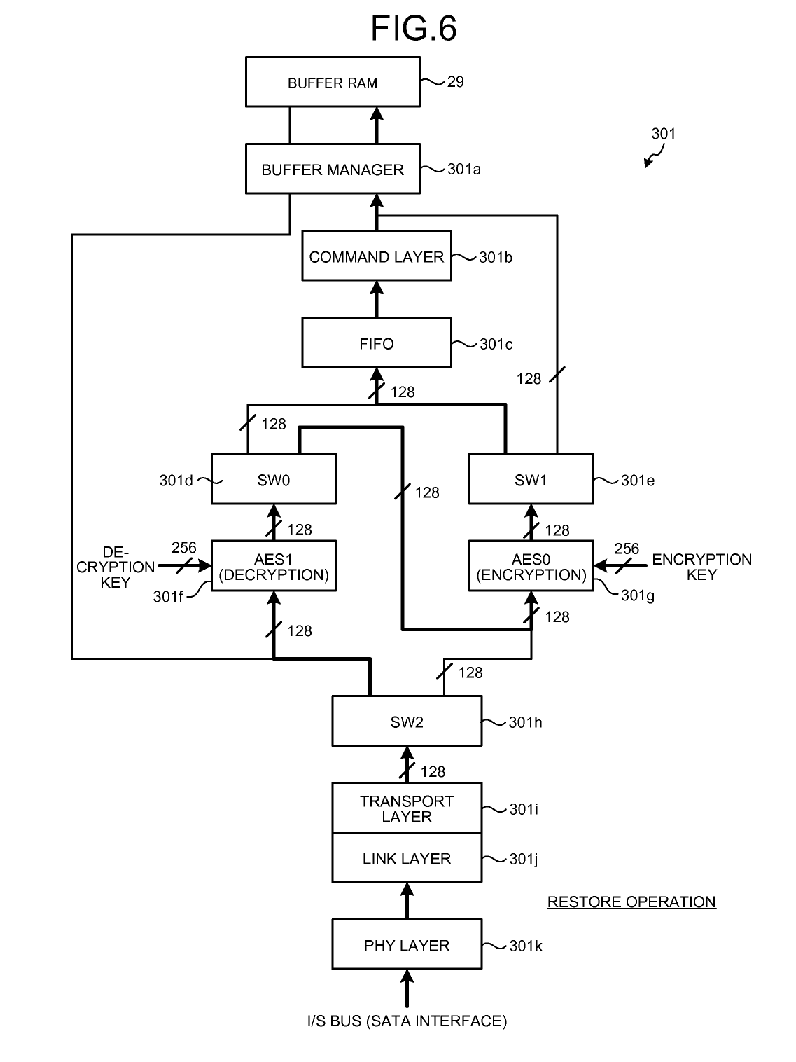

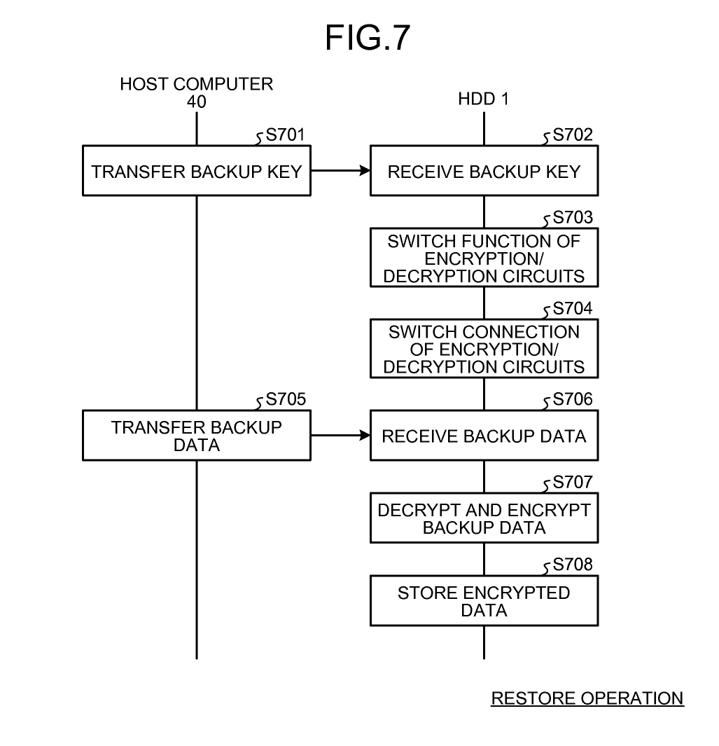

With reference to FIGS. 6 to 8, the restore operation will be described. FIG. 6 is a schematic diagram of a data flow in the host I/F 301 of the HDC 30 at the time of restore. FIG. 7 is a sequence diagram of the operation of the host computer 40 and the HDC 30 of the HDD (magnetic disk device) 1 at the time of restore. FIG. 8 is a schematic diagram of a relationship between the host computer (personal computer) 40 and the HDD 1 at the time of backup and restore.

To restore data backed up by the host computer 40 into the magnetic disk device 1, as illustrates in FIGS. 7 and 8, the host computer 40 transfers the backup key used for the backup operation to the magnetic disk device 1 (S701). The host computer 40 stores the backup key after backing up data received from the magnetic disk device 1.

As illustrated in FIG. 6, the HDC 30 of the controller 31 in the magnetic disk device 1 switches the encryption/decryption circuit (AES1) 301f that receives the data from the host computer 40 to function as a decryptor (S702). On the other hand, the HDC 30 switches the encryption/decryption circuit (AES0) 301g that generates encrypted data to be written to the magnetic disk 11 to function as an encryptor (S703). The encryption/decryption circuits (AES1 and AES0) 301f and 301g are connected in series (S704).

With this connection, the backup data is transferred from the host computer 40 (S705). The host computer 40 can be notified of the data transfer timing by polling therefrom or a predetermined notification sent from the controller 31 to the host computer 40.

When the HDC 30 of the controller 31 receives the backup data from the host computer 40 (S706), the encryption/decryption circuit (AES1) 301f as a decryptor decrypts the backup data using the backup key received from the host computer 40 to restore the backup data. Meanwhile, the encryption/decryption circuit (AES0) 301g as an encryptor encrypts the data previously decrypted with the backup key using the data key generated and retained by the HDC 30 (S707). The encrypted data is stored in the magnetic disk 11 (S708). In this manner, the data transferred from the host computer 40 is decrypted with the backup key by the HDC 30 of the controller 31. The decrypted data is encrypted with the data key and is stored in the magnetic disk 11.

As described above, according to the embodiment, at the time of backup and restore, a plurality of encryption/decryption circuits (301f and 301g), which are generally connected in parallel, are connected in series. With this, data generally exchanged as plaintext with the host computer is encrypted using a backup key and is output as backup data. Thus, the data can be securely backed up. Further, the data encrypted with the backup key and backed up by the host computer is decrypted with the backup key by the HDC 30, and thereby can be restored.

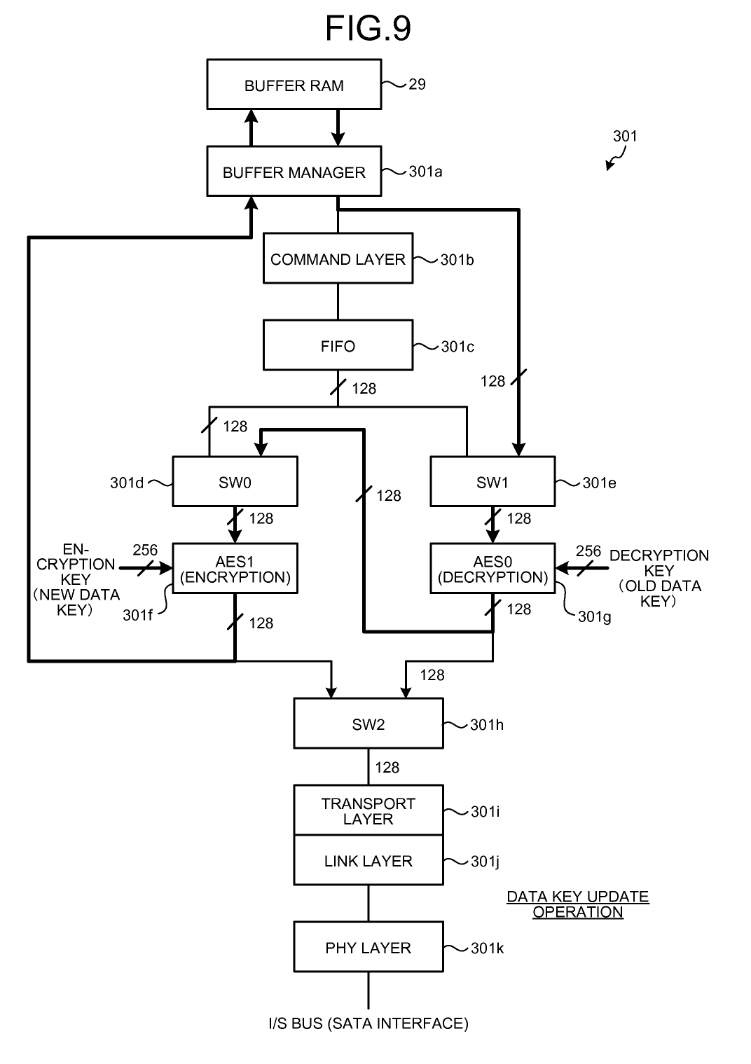

In an HDD with encryption (the magnetic disk device 1, etc.), the data key may be updated to ensure data security. In such a case, an output module (in the case of FIG. 9, the encryption/decryption circuit (AES1) 301f) of the encryption/decryption circuits (AES1 and AES0) 301f and 301g switched to be connected in series as at the time of data backup described above is not connected to the host computer, but is connected, i.e., looped back, to the buffer RAM 29 through the buffer manager 301a (loop connection). FIG. 9 illustrates the connection relationship. With this connection, the encryption/decryption circuit (AES0) 301g as a decryptor performs decryption using an old data key, while the encryption/decryption circuit (AES1) 301f as an encryptor performs encryption using a new data key.

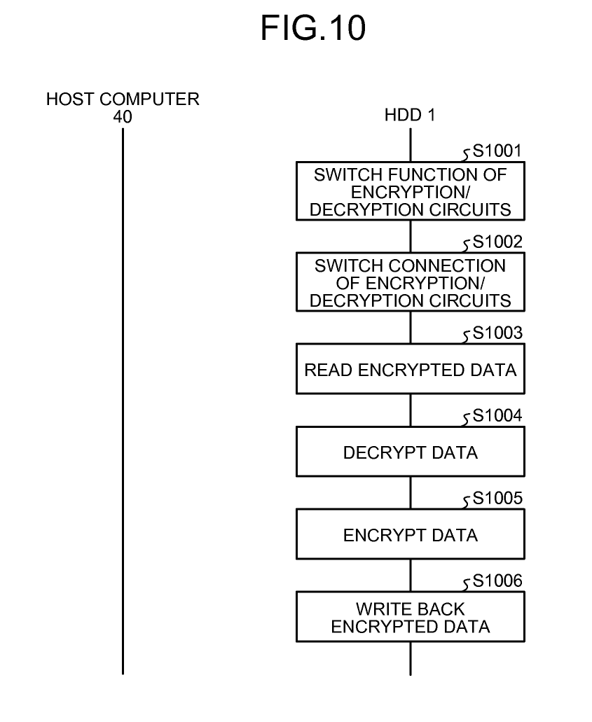

With reference to FIGS. 9 and 10, a description will be given of the operation to update a data key. FIG. 9 is a schematic diagram of a data flow in the host I/F 301 of the HDC 30 at the time of updating a data key. FIG. 10 is a sequence diagram of the operation of the host computer 40 and the HDC 30 of the HDD (magnetic disk device) 1 at the time of updating a data key.

Upon updating a data key, to achieve the above configuration as illustrated in FIG. 9, first, the functions of the encryption/decryption circuits (AES1 and AES0) 301f and 301g are switched (S1001), and then they are switched to be connected in series (S1002). Encrypted data is read from the magnetic disk 11 (S1003). The data read from the magnetic disk 11 into the buffer RAM 29 is encrypted by an old data key. The encryption/decryption circuit (AES0) 301g as a decryptor decrypts the data using the old data key (S1004). After that, the encryption/decryption circuit (AES1) 301f as an encryptor encrypts the data using a new data key (S1005).

The encrypted data is looped back to the buffer RAM 29 via the buffer manager 301a, and thereby the data encrypted with the new data key is loaded into the buffer RAM 29. The data encrypted with the new data key is written back from the buffer RAM 29 to the magnetic disk 11 (S1006). This process is repeated for the entire user data area. Thus, the data key is updated.

As described above, according to the embodiment, using a plurality of encryption/decryption circuits for encrypting data to be stored and decrypting data to be output, data encrypted with a key (an old data key) on the buffer RAM 29 is decrypted in the HDC 30 of the controller 31. Further, the data is encrypted again with a different key (a new data key) and is written back to the buffer RAM 29. With this control, unencrypted plaintext data and a data key are not leaked out of the one-chip controller 31 such as SoC (to the buffer RAM 29, etc.). Accordingly, when a data key used to encrypt data is updated, a new data key and the data can be maintained secret.

While the embodiment is described above as being applied to the magnetic disk device, it is not so limited. The embodiment may be applied to other data storage devices such as a solid state drive (SSD). In addition, the operations illustrated in the sequence diagrams are examples for the purpose of description.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A controller configured to control a data storage device comprising a storage module configured to store data encrypted with a first key, the controller comprising:
an input and output module configured to manage data input and output between the storage module and a host;
a plurality of encryption and decryption modules configured to be switched to function as an encryptor or a decryptor; and
a connector configured to change connection between the encryption and decryption modules and the host,
wherein, when encrypted data is backed up, one of the encryption and decryption modules on a side of the storage module is configured to function as a decryptor, while one of the encryption and decryption modules on a side of the host is configured to function as an encryptor, the decryptor, the encryptor, and the host being connected in series, and
wherein the encrypted data is decrypted by the decryptor with the first key and is then encrypted by the encryptor with a second key to be output from the input and output module to the host.

2. The controller of claim 1, wherein
when backup data encrypted with the second key is restored, the one of the encryption and decryption modules on the side of the host is configured to function as a decryptor, while the one of the encryption and decryption modules on the side of the storage module is configured to function as an encryptor, the decryptor, the encryptor, and the host being connected in series, and
wherein the backup data received by the input and output module from the host is decrypted by the decryptor with the second key and is then encrypted by the encryptor with the first key.

3. The controller of claim 1, further comprising a key generator configured to generate a third key to replace the first key, wherein
when the first key is updated, one of the encryption and decryption modules on a data output upstream side is switched to function as a decryptor, while one of the encryption and decryption modules on a data output downstream side is switched to function as an encryptor, the decryptor, the encryptor, and the storage module being connected in a loop, and
the encrypted data is decrypted by the decryptor with the first key and is then encrypted by the encryptor with the third key generated by the key generator.

4. The controller of claim 1, wherein
the first key is generated in the data storage device, and
the second key is generated by the host.

5. The controller of claim 1, comprised of one chip.

6. A data storage device comprising:
a storage module configured to store data encrypted with a first key;
an input and output module configured to manage data input and output between the storage module and a host;
a plurality of encryption and decryption modules configured to be switched to function as an encryptor or a decryptor; and
a connector configured to change connection between the encryption and decryption modules and the host,
wherein, when encrypted data is backed up, one of the encryption and decryption modules on a side of the storage module is configured to function as a decryptor, while one of the encryption and decryption modules on a side of the host is configured to function as an encryptor,
the decryptor, the encryptor, and the host are connected in series, and
the encrypted data is decrypted by the decryptor with the first key and is then encrypted by the encryptor with a second key to be output from the input and output module to the host.

7. The data storage device of claim 6, wherein
when backup data encrypted with the second key is restored, the one of the encryption and decryption modules on the side of the host is configured to function as a decryptor, while the one of the encryption and decryption modules on the side of the storage module is configured to function as an encryptor,
the decryptor, the encryptor, and the host are connected in series, and
the backup data received by the input and output module from the host is decrypted by the decryptor with the second key and is then encrypted by the encryptor with the first key.

8. The data storage device of claim 6, further comprising a key generator configured to generate a third key to replace the first key, wherein
when the first key is updated, one of the encryption and decryption modules on a data output upstream side is switched to function as a decryptor, while one of the encryption and decryption modules on a data output downstream side is switched to function as an encryptor,
the decryptor, the encryptor, and the storage module are connected in a loop, and
the encrypted data is decrypted by the decryptor with the first key and is then encrypted by the encryptor with the third key generated by the key generator.

9. The data storage device of claim 6, wherein
the first key is generated in the data storage device, and
the second key is generated by the host.

10. The data storage device of claim 6, wherein each module is comprised of one chip.

11. A control method applied to a data storage device comprising a storage module configured to store data encrypted with a first key, an input and output module configured to manage data input and output between the storage module and a host, a plurality of encryption and decryption modules configured to be switched to function as an encryptor or a decryptor, and a connector configured to change connection between the encryption and decryption modules and the host, the control method comprising:
when first encrypted data is backed up,
switching one of the encryption and decryption modules on a side of the storage module to function as a decryptor;
switching one of the encryption and decryption modules on a side of the host to function as an encryptor;
connecting the decryptor, the encryptor, and the host in series;
decrypting the first encrypted data by the decryptor with the first key to obtain first decrypted data;
encrypting the first decrypted data by the encryptor with a second key to obtain second encrypted data; and
outputting the second encrypted data encrypted with the second key from the input and output module to the host.

12. The control method of claim 11, further comprising:
when backup data encrypted with the second key is restored,
switching the one of the encryption and decryption modules on the side of the host to function as a decryptor;
switching the one of the encryption and decryption modules on the side of the storage module to function as an encryptor;
connecting the decryptor, the encryptor, and the host in series;
decrypting the backup data received by the input and output module from the host by the decryptor with the second key to obtain second decrypted data; and
encrypting the second decrypted data by the encryptor with the first key.

13. The control method of claim 11, wherein the data storage device further comprising a key generator configured to generate a third key to replace the first key, the control method further comprising:
when the first key is updated,
switching one of the encryption and decryption modules on a data output upstream side to function as a decryptor;
switching one of the encryption and decryption modules on a data output downstream side to function as an encryptor;
connecting the decryptor, the encryptor, and the storage module in a loop;
decrypting the first encrypted data by the decryptor with the first key to obtain the first decrypted data; and
encrypting the first decrypted data by the encryptor with the third key generated by the key generator.

14. The control method of claim 11, wherein
the first key is generated in the data storage device, and
the second key is generated by the host.

15. The control method of claim 11, performed by a one-chip controller.
